(19) United States
(12) Patent Application Publication
(10) Pub. No.: US 2008/0313551 A1
(43) Pub. Date: Dec. 18, 2008

(54) Apparatus and method for forced linking of product/service offers on a web page

(75) Inventor: Neal D. Rapoport, Plano, TX (US)

Correspondence Address: DOCKET CLERK, P.O. DRAWER 800889, DALLAS, TX, 75380, US

(73) Assignee: NARAE ENTERPRISES, INC., Plano, TX (US)

(21) Appl. No.: 11/811,753

(22) Filed: Jun. 12, 2007

(51) Int. Cl. G06F 17/00; G06F 15/00

(52) U.S. Cl. 715/760

(57) ABSTRACT

A web page that includes offer cells is presented to a user. Each of the offer cells is associated with an offer for a product or a service. Each offer cell may include a boundary and a hyperlink. The user may select an area within one of the offer cells, such as by using a mouse to click within the boundary of the offer cell. A determination is made as to whether the user selected the hyperlink within the offer cell. If so, the user is directed to a destination associated with the hyperlink. Otherwise, the user did not select the hyperlink and instead selected some other area within the offer cell. In this case, the user is directed to a destination associated with the offer cell itself (which may or may not be different from the destination associated with the hyperlink in the offer cell).

### TECHNICAL FIELD

This disclosure is generally directed to web-based systems and more specifically to an apparatus and method for forced linking of product/service offers on a web page.

### BACKGROUND

Many different businesses and other entities operate or support websites, such as websites that present product or service-related information to customers and that accept orders for products or services from customers. Many businesses (either on their own or through affiliated parties) also often provide coupons or other offers for the products and services they provide.

Tracking websites routinely track or compile coupons available for use with various on-line businesses, and coupon codes are made available to members of those tracking websites. For example, a member of a tracking website could access the tracking website and search for coupons related to a particular product or service, a particular store, or a particular product manufacturer or service provider. The tracking website then typically displays any available coupons to the member. Often times, the member is required to copy a particular coupon code, visit an on-line business' website, and enter the coupon code in the appropriate location at the business' website.

### SUMMARY

This disclosure provides an apparatus and method for forced linking of product/service offers on a web page.

In a first embodiment, a method includes receiving information associated with a user's selection within an offer cell displayed in a web page. The offer cell is associated with an offer for a product or service. The method also includes determining if the user selected a hyperlink in the offer cell. The method further includes directing the user to a destination associated with the hyperlink if the user selected the hyperlink in the offer cell. In addition, the method includes directing the user to a destination associated with the offer cell if the user did not select the hyperlink in the offer cell.

In particular embodiments, the offer cell includes a boundary, and the method further includes invoking a function in response to the user's selection within the boundary of the offer cell.

In other particular embodiments, determining if the user selected the hyperlink in the offer cell includes invoking a script using the function, determining if the user selected the hyperlink in the offer cell using the script, and ending the script if the user selected the hyperlink in the offer cell.

In yet other particular embodiments, determining if the user selected the hyperlink in the offer cell and directing the user to the destination associated with the offer cell include determining that the user did not select the hyperlink in the offer cell using the script and directing the user to the destination associated with the offer cell using the script.

In a second embodiment, an apparatus includes at least one memory configured to store information associated with an offer for a product or service. The apparatus also includes at least one processor configured to receive information associated with a user's selection within an offer cell displayed in a web page. The offer cell is associated with the offer for the product or service. The at least one processor is also configured to determine if the user selected a hyperlink in the offer cell, direct the user to a destination associated with the hyperlink if the user selected the hyperlink in the offer cell, and direct the user to a destination associated with the offer cell if the user did not select the hyperlink in the offer cell.

In a third embodiment, a computer program is embodied on a computer readable medium. The computer program includes computer readable program code for receiving information associated with a user's selection within an offer cell displayed in a web page. The offer cell is associated with an offer for a product or service. The computer program also includes computer readable program code for determining if the user selected a hyperlink in the offer cell, directing the user to a destination associated with the hyperlink if the user selected the hyperlink in the offer cell, and directing the user to a destination associated with the offer cell if the user did not select the hyperlink in the offer cell.

In a fourth embodiment, a method includes displaying a web page to a user. The web page includes an offer cell associated with an offer for a product or service, and the displayed offer cell includes a hyperlink. The method also includes receiving information associated with a user's selection within the offer cell, where the user's selection is not associated with the hyperlink in the offer cell. The method further includes displaying information associated with the offer to the user, where the information is retrieved from a destination associated with the offer cell.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example system for forced linking of product/service offers on a web page according to this disclosure;

FIGS. 2A and 2B illustrate an example web page supporting forced linking of product/service offers according to this disclosure; and

FIG. 3 illustrates an example method for forced linking of product/service offers on a web page according to this disclosure.

### DETAILED DESCRIPTION

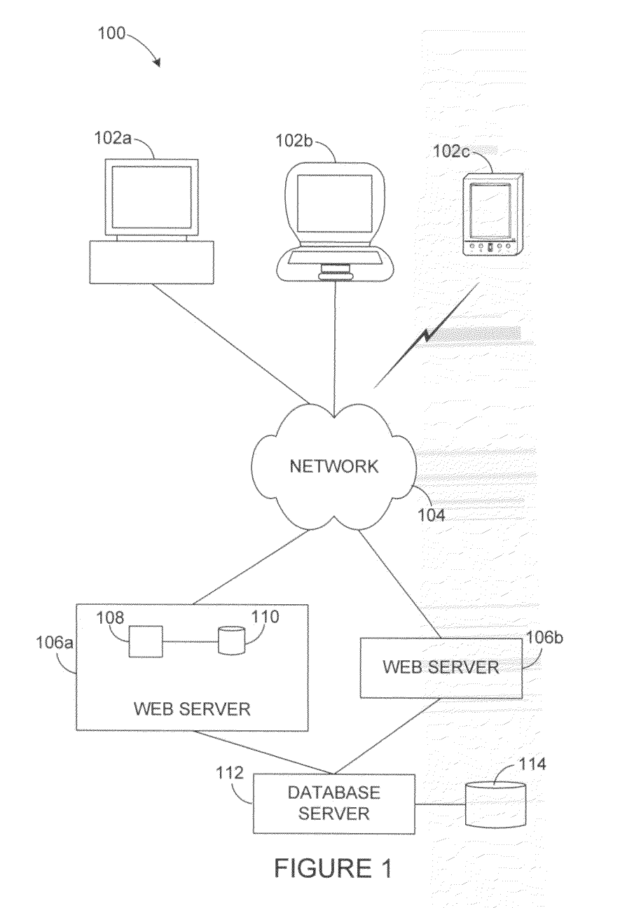

FIGS. 1 through 3, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 for forced linking of product/service offers on a web page according to this disclosure. The embodiment of the system 100 shown in FIG. 1 is for illustration only. Other embodiments of the system 100 may be used without departing from the scope of this disclosure.

In this example embodiment, the system 100 includes various end user devices 102a-102c. Each of the user devices 102a-102c communicates over a network 104. For example, each of the user devices 102a-102c may receive and display a web page to a user, and the user could use the user device 102a-102c to provide information via the web page, such as by providing information identifying a product or service to be searched. As described in more detail below, at least some of the web pages received by the user devices 102a-102c contain information identifying coupons or other offers for products or services. In this particular example, the user devices 102a-102c include a desktop computer (102a), a laptop computer (102b), and a personal digital assistant (102c). Each of these user devices 102a-102c communicates over a wired or wireless connection. These user devices 102a-102c are for illustration only. Any other or additional computing or communication devices may be used in the system 100. Each of the user devices 102a-102c includes any suitable structure allowing a user to communicate and interact over a network.

A network 104 is capable of communicating with the user devices 102a-102c and with various other components attached to the network 104. The network 104 facilitates communication between components in the system 100. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate type of protocol or protocols, such as Ethernet, IP, X.25, frame relay, or any other protocol.

In this example, two web servers 106a-106b are coupled to the network 104. The web servers 106a-106b support communication and interaction with the user devices 102a-102c over the network 104. For example, the web servers 106a-106b may generate web pages and provide the web pages to the user devices 102a-102c over the network 104. As particular examples, the web servers 106a-106b may generate a main web page or home page for a particular coupon or other offer-tracking entity. The home page could provide users with information associated with coupons or other offers from various businesses. The home page could also allow the users to enter search criteria for locating particular coupons or other offers, or the home page could support or provide access to other mechanisms for browsing or locating coupons or other offers. The web servers 106a-106b could also provide additional web pages to the user devices 102a-102c, such as web pages containing coupons or other offers identified using the users' search criteria. In this document, the term “offer” and its derivatives refer to any offer to provide a product or service. For example, offers include an offer to sell a product or service at a specified price or an offer to sell a product or service at a discounted price (such as a price reduced via a coupon, sale, or other deal). As particular examples, offers include an offer contained in price search results (such as a search performed to identify different stores or other entities' prices for a product or service) or an offer for a product or service identified in a gift registry.

In this particular example, two web servers 106a-106b are shown as being coupled to the network 104. In this embodiment, both web servers 106a-106b could be used to facilitate communications with the user devices 102a-102c. Also, any suitable technique could be used to route individual user devices 102a-102c to specific ones of the web servers 106a-106b, such as by using load-sharing techniques.

The web servers 106a-106b could support additional functionality related to the presentation of coupons or other offers to users. For example, the web servers 106a-106b could support or provide a forum for users to interact. In these forums, members could identify and discuss coupons or other offers for products or services, as well as any other information associated with products or services provided by on-line or other businesses. In particular embodiments, the web servers 106a-106b could allow forum members to identify coupons or other offers for various products and services, and the web servers 106a-106b could then notify other users of those other offers (such as by including information identifying those offers in web pages presented to the other users).

The web servers 106a-106b could use any suitable protocol(s) to communicate with the user devices 102a-102c. For example, the web servers 106a-106b could support the use of hypertext markup language (HTML) to communicate web pages to the user devices 102a-102c. The web servers 106a-106b could also support Secure Sockets Layer (SSL) or other techniques to facilitate secure communications with the user devices 102a-102c.

Each of the web servers 106a-106b includes any suitable structure for providing coupon or other offer-related information to user devices. As a particular example, each of the web servers 106a-106b could include one or more processors 108 and one or more memories 110 containing instructions and data used, generated, or collected by the one or more processors 108.

A database server 112 is coupled to the web servers 106a-106b and a database 114. The database 114 stores various information used, collected, or generated by the web servers 106a-106b. For example, the database 114 could store information identifying coupons or other offers for products or services. The web servers 106a-106b could access and use this information to identify and present specific coupons or other offers to users of the user devices 102a-102c. The database 114 could also store information provided by members of a forum supported by the web servers 106a-106b. The database server 112 provides access to and control over the data stored in the database 114. For instance, the database server 112 can support the storage of data in and the retrieval of data from the database 114. The database server 112 may also ensure that components attempting to access the database 114 are authorized.

The database server 112 includes any suitable structure for providing access to a database of information. The database 114 includes any suitable structure for storing and facilitating retrieval of information. The database 114 also uses any of a variety of data structures, arrangements, and compilations to store and facilitate retrieval of information.

In one aspect of operation, the web servers 106a-106b generate and provide web pages to the user devices 102a-102c for presentation to users. The web pages include or identify coupons or other offers associated with products or services. Offers in a web page can be presented to a user in various ways. For example, the user could provide search criteria, and a web server 106a-106b could provide the user with a list of offers for products or services matching the user's search criteria. As another example, the user could submit a request to view someone's gift registry, and a web server 106a-106b could provide the user with a list of offers for products or services listed in the gift registry.

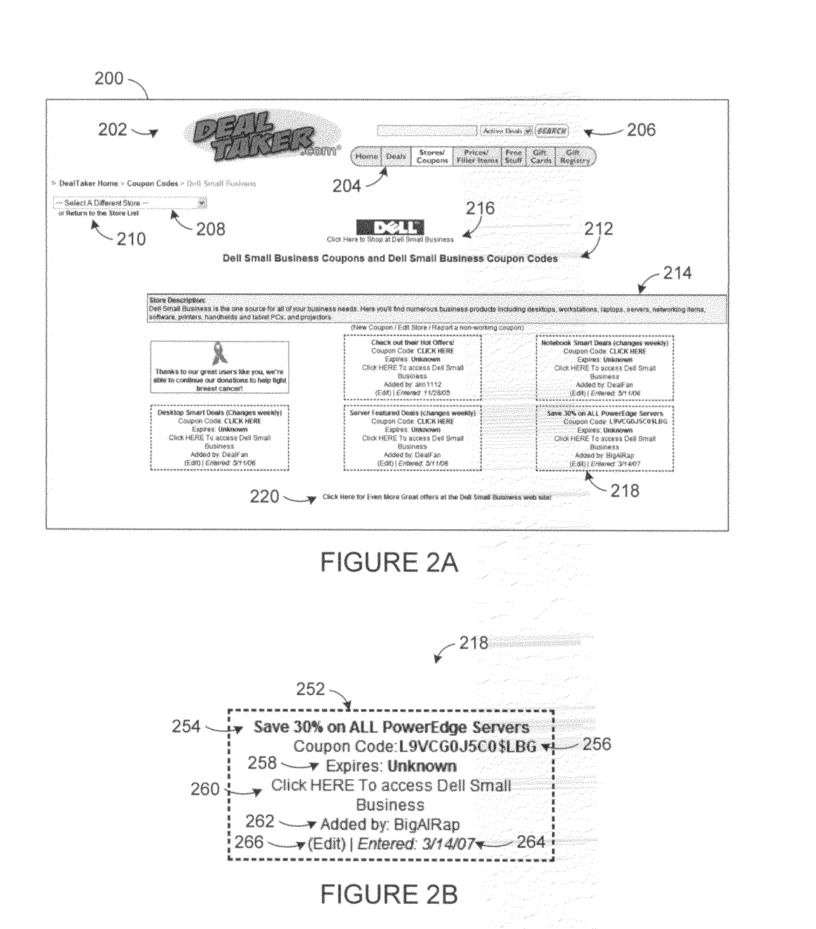

As explained below with reference to FIGS. 2A and 2B, each offer could be identified in a web page in any suitable manner, such as by identifying the offer within a box or other cell displayed in the web page. Also, the web servers 106a-106b support forced linking for offers displayed on the web page. With forced linking, the user is redirected to a different web page associated with an offer when the user clicks any area associated with the offer, such as any portion of an offer's cell displayed in the web page. The term “click” and its derivatives refer to a selection by a user using an input device, such as a mouse selection or a keyboard selection. For example, clicking any area within an offer's cell being displayed in the user's web browser window may redirect the web browser window to a manufacturer, service provider, or vendor's website where a product or service is for sale. As another example, clicking any area within an offer's cell being displayed in the user's web browser window may cause a new browser window to open and display the manufacturer, service provider, or vendor's website.

In some embodiments, each offer displayed in a cell to a user could include one or more hyperlinks in the cell, such as hyperlinks providing access to an on-line business' website. In these embodiments, the web servers 106a-106b could support different functions depending on what the user selects within the cell associated with an offer. For example, if the user clicks a hyperlink in the offer's cell, the web servers 106a-106b could redirect the user's web browser to a destination associated with the hyperlink. If the user clicks within the offer's cell but does not select a hyperlink in the cell, the user could be redirected to the forced linking location as described above.

Although FIG. 1 illustrates one example of a system 100 for forced linking of product/service offers on a web page, various changes may be made to FIG. 1. For example, the system 100 may include any number of user devices, networks, web servers, database servers, and databases. Also, the functional division shown in FIG. 1 is for illustration only. Various components in FIG. 1 could be combined or omitted and additional components could be added according to particular needs. In addition, while FIG. 1 illustrates one operational environment in which forced linking can be used, the forced linking mechanisms could be used in any other suitable system (whether or not that system provides coupon or other offer-related information to users).

FIGS. 2A and 2B illustrate an example web page 200 supporting forced linking of product/service offers according to this disclosure. In particular, FIG. 2A illustrates a web page 200, and FIG. 2B illustrates one portion of the web page 200. The embodiment of the web page 200 shown in FIGS. 2A and 2B is for illustration only. Other embodiments of the web page 200 could be used without departing from the scope of this disclosure.

As shown in FIG. 2A, the web page 200 includes various information and controls at the top of the web page 200. For example, the web page 200 includes a logo 202 identifying the company that owns or operates the website being accessed. The web page 200 also includes various tabs 204, which can be used to access different types of information. In this case, a “Stores/Coupons” tab 204 has been selected.

The web page 200 further includes various mechanisms for searching for coupons or other offers from various businesses or other entities. For example, the web page 200 supports a text search 206, which allows a user to search for desired offers. As a particular example, the user could enter text (such as a product, manufacturer, or store name), specify which offers to search (such as active or expired offers), and initiate the search. The web page 200 also includes a drop-down menu 208 containing a list of stores or other entities that can be selected by the user. In addition, the web page 200 includes a hyperlink 210 that can be selected in order to view a complete list of stores or other entities that can be selected by the user.

The remainder of the web page 200 in FIG. 2A contains information associated with a selected product, service, or entity (such as a manufacturer, service provider, or vendor). In this example, the remainder of the web page 200 contains information associated with a selected computer store. In particular, the web page 200 includes text 212 identifying the selected store, a description 214 of the selected store, and a hyperlink 216 to the selected store's website.

The web page 200 also includes one or more offer cells 218, each of which is associated with a different coupon or other offer related to the selected store. Each of the offer cells 218 identifies various information associated with the coupon or other offer for a product or service provided by the selected store. In addition, the web page 200 includes a hyperlink 220 that can be selected by the user to view additional offer cells 218 (if any) associated with the selected store. In particular embodiments, the most popular offers could be displayed first in the offer cells 218 followed by less popular offers, although any other suitable technique could be used to determine which offer cells 218 are displayed first.

One example embodiment of the offer cells 218 is shown in FIG. 2B. In FIG. 2B, the offer cell 218 includes a boundary 252. The boundary 252 defines the overall shape and size of the offer cell 218 in the web page 200. The boundary 252 also defines the area in which forced linking can occur, meaning the user can click anywhere within the boundary 252 to invoke the forced linking mechanism described above. In this example, the boundary 252 is rectangular. However, an offer cell 218 could have any other suitable boundary. For example, the boundary 252 could represent a row, column, or individual cell in a table. The boundary 252 could also represent an area within a web page that is defined by JavaScript <DIV> tags. The boundary 252 could further represent any suitable geometric shape displayed on a web page.

Within the boundary 252, each cell 218 includes various information associated with a coupon or other offer. For example, the cell 218 includes a short description 254 of the offer, such as an identification of the product and a price or coupon offer associated with the product. The cell 218 also includes a coupon code 256, which in this example represents a code used at an on-line business' website to receive the offer associated with the cell 218. In other embodiments, the actual coupon code itself could be replaced by a hyperlink (such as a hyperlink labeled “CLICK HERE”) that redirects a user to an on-line business' website associated with the offered product or service. An expiration date 258 (if any) identifies when the offer expires, and a hyperlink 260 can be selected to redirect the user to an on-line business' website.

As shown in FIG. 2B, additional information and options are also contained in the cell 218. As described above, various users, such as forum members, could identify offers for on-line or other businesses. In these embodiments, an offer cell 218 could identify a username 262 associated with the user who created or added the offer to a database. The offer cell 218 could also include a date stamp 264 identifying when the offer was added to the database. In addition, an edit link 266 can be provided allowing users to edit and possibly delete an offer. In some embodiments, various portions of the offer cell 218 (such as elements 262-266) could be hidden from most users and only made visible to or accessible by certain users (such as administrators or moderators).

In some embodiments, each offer cell 218 can include one or more hyperlinks (such as hyperlink 260 and a hyperlink associated with the coupon code 256). Also, each offer cell 218 itself is associated with a Uniform Resource Location (URL), which is separate from any URL(s) associated with any hyperlink(s) in the cell 218 (although the URL associated with the offer cell 218 could equal the URL associated with one of the hyperlinks in the cell 218).

In particular embodiments (such as those using JavaScript in the web servers 106a-106b), each offer cell 218 can be associated with an “onclick” function, which determines when a user clicks within the offer cell 218. Also, each hyperlink in an offer cell 218 is associated with an “onmousedown” or “onmouseup” function. The “onclick” function associated with an offer cell 218 determines when a user clicks a mouse button or other user interface device within the offer cell's boundary 252. When that occurs, the “onclick” function invokes a script, which determines if a hyperlink in the offer cell 218 has been selected using the “onmousedown” or “onmouseup” function. If a hyperlink has been selected, the script ends, and the user is redirected to the destination associated with the selected hyperlink. Otherwise, the script redirects the user to the URL associated with the offer cell 218 (such as by redirecting a browser window or opening a new browser window).

In this way, the user is more easily redirected to an on-line business' website or other destination associated with an offer cell 218. For example, a user might ordinarily attempt to copy the coupon code 256 in the offer cell 218 by left-clicking a mouse button and attempting to drag the mouse cursor across the coupon code 256 (highlighting the coupon code and allowing the user to electronically copy it). In these embodiments, the script executed by the web servers 106a-106b can detect the clicking of the mouse button when the mouse cursor is within the offer cell's boundary 252 (but not on a hyperlink in the offer cell 218) and redirect the user to an intended destination associated with the offer cell 218 (such as a manufacturer or store's website). The user is not required to copy the coupon code and then paste the coupon code into the appropriate location at the intended destination. Moreover, some websites earn money by redirecting users to other websites, such as when a tracking website earns money each time it redirects a user to a particular company's website. The use of this redirection mechanism can help to increase the web traffic redirected from the tracking website to another, helping to increase the revenue of the tracking website.

In particular embodiments, a mouse cursor typically has a first form (such as a pointer) when the mouse cursor is over blank areas of the web page 200, a second form (such as an I shape) when located over text in the web page 200, and a third shape (such as a hand with a pointing index finger) when located over a hyperlink in the web page 200. In these embodiments, the mouse cursor could take similar forms when placed within the boundary 252 of an offer cell 218. However, when inside the boundary 252 of the offer cell 218, the mouse button could be depressed at any time, and the user can be redirected by the forced linking mechanism of the offer cell 218. This could occur even when the user's mouse cursor is taking the first or second form (forms not typically associated with an ability to select a hyperlink and be redirected). In this way, from the end user's perspective, the fact that the entire offer cell 218 acts as a hyperlink or redirection mechanism can be concealed.

Although FIGS. 2A and 2B illustrate one example of a web page 200 supporting forced linking of product/service offers, various changes may be made to FIGS. 2A and 2B. For example, the web page 200 could include any other or additional information, and the web page 200 could have any suitable arrangement and layout. Also, the contents of the offer cell 218 are for illustration only. An offer cell 218 could include any other or additional information in any suitable arrangement and layout.

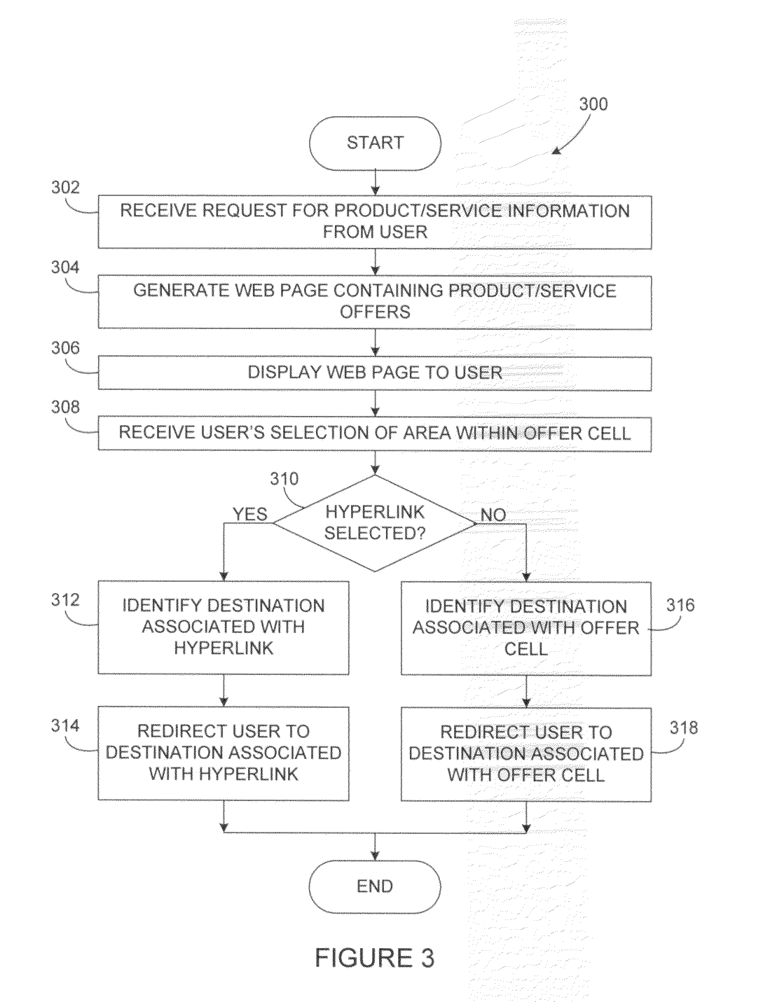

FIG. 3 illustrates an example method 300 for forced linking of product/service offers on a web page according to this disclosure. The embodiment of the method 300 shown in FIG. 3 is for illustration only. Other embodiments of the method 300 could be used without departing from this disclosure. Also, for ease of explanation, the method 300 is described with respect to the web page 200 of FIGS. 2A and 2B being used in the system 100 of FIG. 1. The method 300 could be used with any suitable web page generated or used in any suitable system.

A request for product/service information is received from a user at step 302. This could include, for example, a web server 106a-106b receiving a request for product or service information from a user over the network 104. As a particular example, the user may access a home page provided by the web server 106a-106b, and the user could provide search information using the web page. The search information could request information about a particular product or service, a particular type of product or service, a particular product manufacturer or service provider, or a particular store or other entity that provides a product or service.

A web page containing product/service offers is generated at step 304. This could include, for example, the web server 106a-106b generating a web page 200 that contains one or more offer cells 218 identifying one or more offers. The offers could be for a particular product or service, a particular type of product or service, a particular product manufacturer or service provider, or a particular store or other entity. The web server 106a-106b could use information stored in the database 114 (which is accessible via the database server 112) to generate the web page 200.

The web page is displayed to the user at step 306. This could include, for example, the web server 106a-106b communicating the web page 200 using HTML to a user device 102a-102c used by the user. This may also include the user device 102a-102c presenting the generated web page 200 to the user.

A user's selection of a particular area within an offer cell in the web page is received at step 308. This could include, for example, receiving information indicating that the user has used a mouse to click on a position within one of the offer cells 218 presented to the user.

If the user has selected a hyperlink displayed in the offer cell at step 310, the user is redirected to a destination based on the hyperlink. For example, a destination associated with the hyperlink is identified at step 312, such as by identifying a URL associated with the selected hyperlink. Also, the user is redirected to the identified destination at step 314, such as by redirecting the user device 102a-102c to the URL associated with the selected hyperlink. At this point, the method 300 ends.

If the user did not select a hyperlink displayed in the offer cell at step 310, this indicates that the user has clicked on an area in the offer cell other than a hyperlink. In this case, the forced linking mechanism is invoked. A destination associated with the offer cell itself is identified at step 316, such as by identifying a URL associated with the offer cell 218. This URL could be the same as or different from the URL associated with a hyperlink in the offer cell 218. Also, the user is redirected to the identified destination at step 318, such as by redirecting the user device 102a-102c to the URL associated with the offer cell 218. Again, at this point, the method 300 ends.

In this way, the user is redirected to a destination associated with an offer, whether the user actually selects a hyperlink in an offer cell 218 or simply clicks anywhere within the offer cell 218. This could help increase the traffic that is redirected from a tracking website, such as a website that redirects users to businesses' websites in exchange for payment from the businesses. Moreover, this makes it easier for the user to reach a business' website and accept a desired offer, since the user need not actually copy and paste a coupon code or select an appropriate hyperlink within the offer cell 218.

Although FIG. 3 illustrates one example of a method 300 for forced linking of product/service offers on a web page, various changes may be made to FIG. 3. For example, an offer cell 218 could include any number of hyperlinks (including zero).

In some embodiments, various functions described above can be implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
receiving information associated with a user's selection within an offer cell displayed in a web page, the offer cell associated with an offer for a product or service;
determining if the user selected a hyperlink in the offer cell;
directing the user to a destination associated with the hyperlink if the user selected the hyperlink in the offer cell; and
directing the user to a destination associated with the offer cell if the user did not select the hyperlink in the offer cell.

2. The method of claim 1, wherein:
the offer cell includes a boundary; and
further comprising invoking a function in response to the user's selection within the boundary of the offer cell.

3. The method of claim 2, wherein determining if the user selected the hyperlink in the offer cell comprises:
invoking a script using the function;
determining if the user selected the hyperlink in the offer cell using the script; and
ending the script if the user selected the hyperlink in the offer cell.

4. The method of claim 3, wherein determining if the user selected the hyperlink in the offer cell and directing the user to the destination associated with the offer cell comprise:
determining that the user did not select the hyperlink in the offer cell using the script; and
directing the user to the destination associated with the offer cell using the script.

5. The method of claim 1, wherein:
the destination associated with the hyperlink comprises a first Uniform Resource Locator; and
the destination associated with the offer cell comprises a second Uniform Resource Locator.

6. The method of claim 5, wherein the first and second
Uniform Resource Locators are different.

7. The method of claim 1, wherein:
the offer cell comprises one of a plurality of offer cells in the web page; and
at least some of the offer cells include multiple hyperlinks.

8. The method of claim 1, wherein directing the user to the destination associated with the offer cell comprises at least one of:
causing a user device associated with the user to redirect a first web browser window to the destination associated with the offer cell; and
causing the user device to open a second web browser window and to direct the second web browser window to the destination associated with the offer cell.

9. The method of claim 1, wherein receiving the information associated with the user's selection within the offer cell comprises receiving information associated with a selection made by the user using a mouse.

10. An apparatus comprising:
at least one memory configured to store information associated with an offer for a product or service; and
at least one processor configured to:
receive information associated with a user's selection within an offer cell displayed in a web page, the offer cell associated with the offer for the product or service;
determine if the user selected a hyperlink in the offer cell;
direct the user to a destination associated with the hyperlink if the user selected the hyperlink in the offer cell; and
direct the user to a destination associated with the offer cell if the user did not select the hyperlink in the offer cell.

11. The apparatus of claim 10, wherein:
the offer cell includes a boundary; and
wherein the at least one processor is further configured to invoke a function in response to the user's selection within the boundary of the offer cell.

12. The apparatus of claim 11, wherein the at least one processor is configured to determine if the user selected the hyperlink in the offer cell by:
invoke a script using the function;
determine if the user selected the hyperlink in the offer cell using the script; and
end the script if the user selected the hyperlink in the offer cell.

13. The apparatus of claim 12, wherein the at least one processor is configured to determine if the user selected the hyperlink in the offer cell and to direct the user to the destination associated with the offer cell by:
determining that the user did not select the hyperlink in the offer cell using the script; and
directing the user to the destination associated with the offer cell using the script.

14. The apparatus of claim 10, wherein:
the destination associated with the hyperlink comprises a first Uniform Resource Locator; and
the destination associated with the offer cell comprises a second Uniform Resource Locator.

15. The apparatus of claim 14, wherein:
the information associated with the user's selection within the offer cell comprises information associated with a mouse selection, the mouse selection associated with a mouse cursor displayed to the user; and
the mouse cursor does not change form to indicate the existence of the second Uniform Resource Locator when the mouse cursor is placed over the offer cell.

16. The apparatus of claim 10, wherein:
the offer cell comprises one of a plurality of offer cells in the web page; and
at least some of the offer cells include multiple hyperlinks.

17. The apparatus of claim 10, wherein the at least one processor is configured to direct the user to the destination associated with the offer cell by at least one of:
causing a user device associated with the user to redirect a first web browser window to the destination associated with the offer cell; and
causing the user device to open a second web browser window and to direct the second web browser window to the destination associated with the offer cell.

18. The apparatus of claim 10, wherein the at least one processor is further configured to generate the web page.

19. The apparatus of claim 10, wherein the apparatus comprises a web server.

20. A computer program embodied on a computer readable medium, the computer program comprising computer readable program code for:
receiving information associated with a user's selection within an offer cell displayed in a web page, the offer cell associated with an offer for a product or service;
determining if the user selected a hyperlink in the offer cell;
directing the user to a destination associated with the hyperlink if the user selected the hyperlink in the offer cell; and
directing the user to a destination associated with the offer cell if the user did not select the hyperlink in the offer cell.

21. The computer program of claim 20, wherein:
the offer cell includes a boundary; and
further comprising computer readable program code for invoking a function in response to the user's selection within the boundary of the offer cell.

22. The computer program of claim 21, wherein the computer readable program code for determining if the user selected the hyperlink in the offer cell comprises computer readable program code for:
invoking a script using the function;
determining if the user selected the hyperlink in the offer cell using the script; and
ending the script if the user selected the hyperlink in the offer cell.

23. The computer program of claim 22, wherein the computer readable program code for determining if the user selected the hyperlink in the offer cell and the computer readable program code for directing the user to the destination associated with the offer cell comprise computer readable program code for:
determining that the user did not select the hyperlink in the offer cell using the script; and
directing the user to the destination associated with the offer cell using the script.

24. The computer program of claim 20, wherein:
the destination associated with the hyperlink comprises a first Uniform Resource Locator; and
the destination associated with the offer cell comprises a second Uniform Resource Locator.

25. The computer program of claim 24, wherein the first and second Uniform Resource Locators are different.

26. The computer program of claim 20, wherein:
the offer cell comprises one of a plurality of offer cells in the web page; and
at least some of the offer cells include multiple hyperlinks.

27. The computer program of claim 20, further comprising computer readable program code for generating the web page.

28. The computer program of claim 20, wherein the computer readable program code for directing the user to the destination associated with the offer cell comprises computer readable program code for at least one of:
causing a user device associated with the user to redirect a first web browser window to the destination associated with the offer cell; and
causing the user device to open a second web browser window and to direct the second web browser window to the destination associated with the offer cell.

29. A method comprising:
displaying a web page to a user, the web page comprising an offer cell associated with an offer for a product or service, the displayed offer cell including a hyperlink;
receiving information associated with a user's selection within the offer cell, the user's selection not associated with the hyperlink in the offer cell; and
displaying information associated with the offer to the user, the information retrieved from a destination associated with the offer cell.

30. The method of claim 29, wherein:
a destination associated with the hyperlink comprises a first Uniform Resource Locator; and
the destination associated with the offer cell comprises a second Uniform Resource Locator.
